(19) United States
(12) Patent Application Publication
(10) Pub. No.: US 2008/0188107 A1
(43) Pub. Date: Aug. 7, 2008

(54) SUBMERSIBLE ELECTRICAL CONNECTOR ASSEMBLY AND METHOD OF FORMING SAME

(75) Inventors: Jorge L. Garcia, Plantation, FL (US); Travis R. Coleman, Sunrise, FL (US); Christopher D. Crawford, Hollowood, FL (US); Chee Hian Lee, Alor Star (MY); David H. McClintock, Georgetown (MY); Kin Fatt Phoon, Ipoh (MY)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/670,268

(22) Filed: Feb. 1, 2007

(51) Int. Cl. H01R 13/523

(52) U.S. Cl. 439/271

(57) ABSTRACT

A submersible electrical connector assembly (300) includes an electrical connector (301) mounted to a first substrate (309) where a second substrate (311) adjoins the first substrate (309). The second substrate (311) is comprised of a pliable material that acts as a seal. The first substrate and second substrate are positioned within a compartmentalized area of an electrical device housing for preventing water or other fluid from entering an aperture within the housing. Although water may inadvertently enter the electrical connector (301), the connector assembly (300) is substantially submersible since water is prevented from entering the housing (400) as used for an electronic device.

### FIELD OF THE INVENTION

The present invention relates generally to electrical connectors and more particularly to audio connector assemblies that work to prevent the entry of water into an electronic device.

### BACKGROUND

Electrical connectors used with electronic devices such as cellular telephone, radio and MP3 players are typically used for connecting the device to various types of peripheral equipment and accessories. However, water intrusion though these electrical connectors into the device is a major mechanical issue leading to field returns of these products. Prior art FIGS. 1 and 2, illustrate a side sectional view of standard electrical connector assembly 100 where a connector body 101 is used in connection with a housing 103. As best seen in FIG. 1, a dust cover or plug 104 is used to cover the opening in the housing 103 when not in use. A portion of the plug frictionally engages within the opening to prevent entry of dirt, dust, fluids or other airborne debris.

As seen in prior art FIG. 2, when a male connector 105 or other jack is used with the connector body 101, a gap 107 can be created between the body 101 and housing 103. Moreover a space 109 may also open between the connector body 101 and the plug 105. In the event the device were accidentally or intentionally submerged, this will directly expose any internal electronics 111 of the device so as to make the device inoperable.

Those skilled in the art will also recognize that many differing types of connectors have been used which attempt to prevent the entry of liquids into electronic devices. Prior art FIG. 3 illustrates a side sectional view of a connector assembly 200 and its association with the equipment housing. A connector body 201 is typically mounted within a housing 203. A plug or cover 205 is used to seal an aperture 207 between the connector body 201 and the housing 203. The connector body 201 is over-molded so as to create a seal 209 when the connector body is frictionally mounted within the housing 203. One problem associated with this type of configuration is that these types of over molded connectors are costly to manufacture. Moreover, although this over molding process prevents water from contacting internal components through the use of a seal 209, the over molded type of seal has a poor long term reliability especially when submerged in water or other fluids. If the electronic device is intentionally or accidentally submerged, water is likely to breach the seal 209 leading to an inoperative device.

Thus, the problem with many of the approaches used in the prior art is that the connector are not intended to be submerged. Additionally, without an accompanying jack or plug, the opening in the connector will not prevent water from directly entering the electronic device. Accordingly, the need exists to provide a connector which overcomes these shortcomings that will act to prevent the entry of water and other liquids when directly submerged.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 and FIG. 2 are side sectional views of an electrical connector as used in the prior art.

FIG. 3 is side sectional view of an alternative electrical connector as used in the prior art.

FIG. 4 is a top perspective view of submersible electrical connector assembly in accordance with an embodiment of the present invention.

FIG. 5 is a bottom perspective view of the submersible electrical connector assembly as shown in FIG. 4.

FIG. 6 is a top perspective view of the compartment and aperture used in connection with the submersible electrical connector assembly.

FIG. 7 is a top perspective view of the submersible electrical connector assembly installed in the compartment.

FIG. 8 is a top perspective view of submersible electrical connector assembly with a cover over the cavity and loaded against the assembly.

FIG. 9 is a side sectional view of the submersible electrical connector assembly as shown in FIG. 4 with a male connector inserted in the assembly.

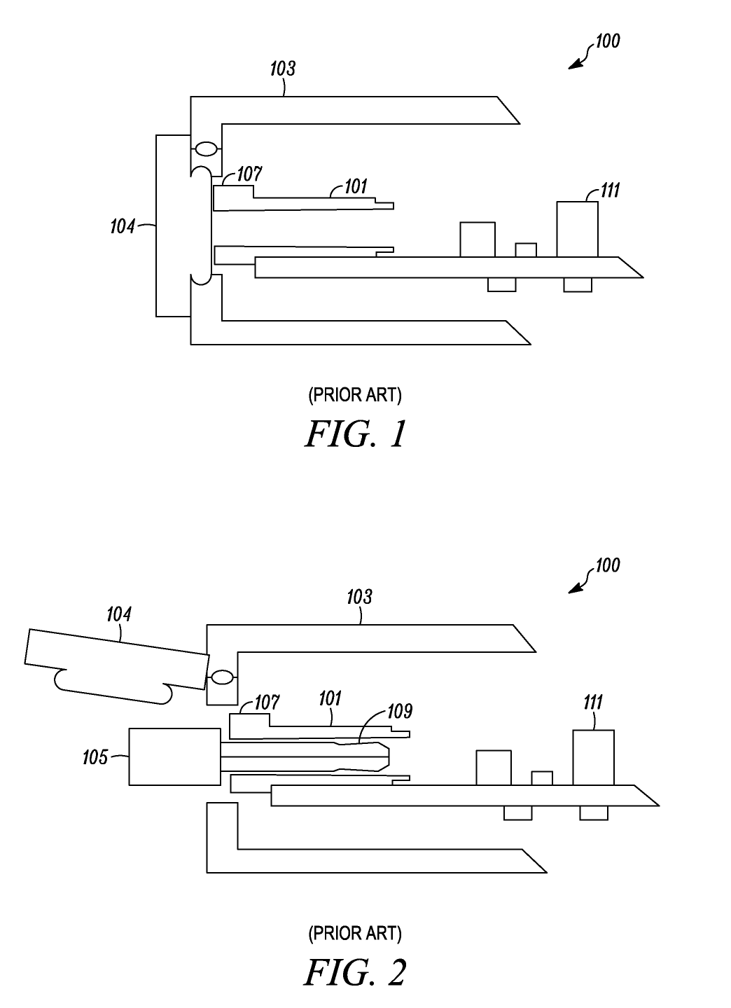

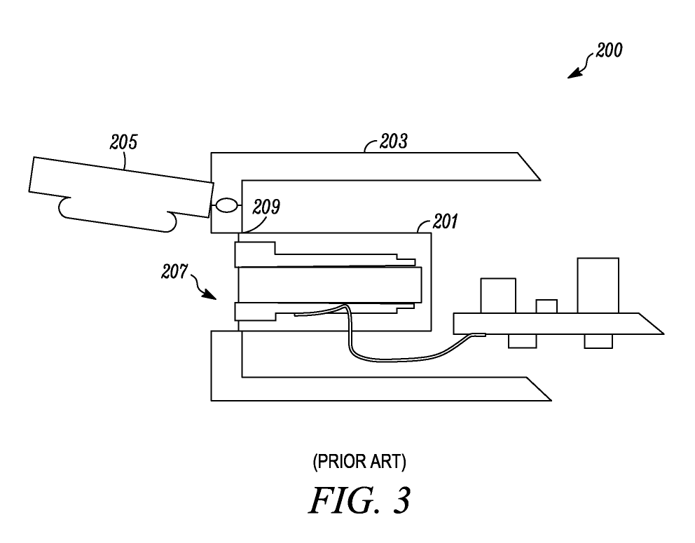

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a submersible electrical connector assembly. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

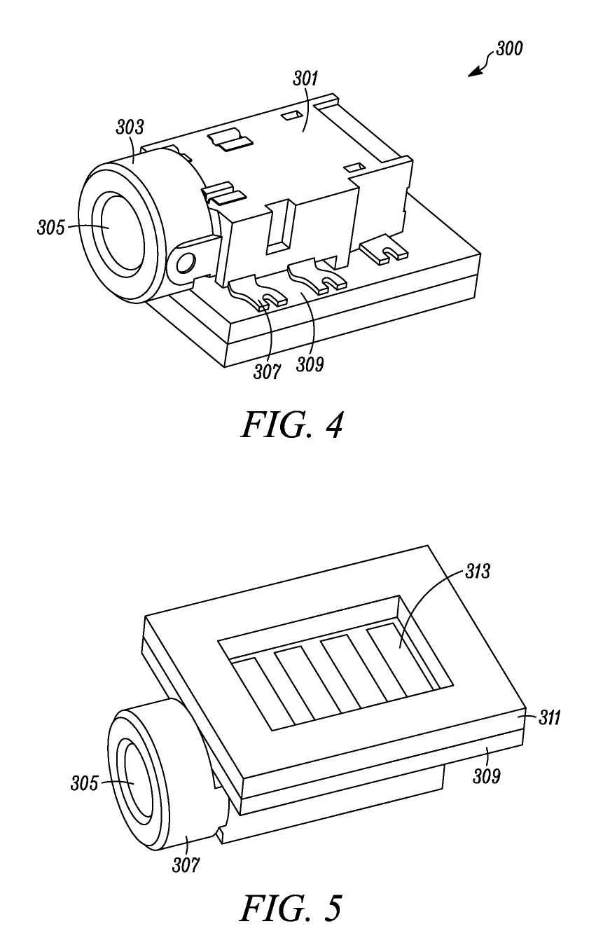

FIG. 4 is a top perspective view of submersible electrical connector assembly 300 in accordance with an embodiment of the present invention. The electrical connector assembly 300 includes body or housing 301 connected with a cylindrical ring 303 forming an aperture 305. Those skilled in the art will recognize that although the electrical connector as depicted in FIG. 4 is a standard 9 mm connector, commonly used in the industry, any type of printed circuit (PC) mount connector having a similar configuration can be used. The connector assembly further includes one or more solder pads 307 which are electrically connected to traces (not shown) on a substrate 309 which may be standard FR-4 board or the like.

FIG. 5 is a bottom perspective view of the submersible electrical connector assembly as shown in FIG. 4. Under the substrate 309, a adhesive type pad 311 is mounted to the surface of the substrate 309. A material having a very high bonding capability is preferable for this type of application. The pad 311 is cut into a configuration allowing access to one or more pads 313 positioned on the substrate 309. As shown herein, contact pins or other electrical connectors may be used to connect the pads 313 to electrical circuitry.

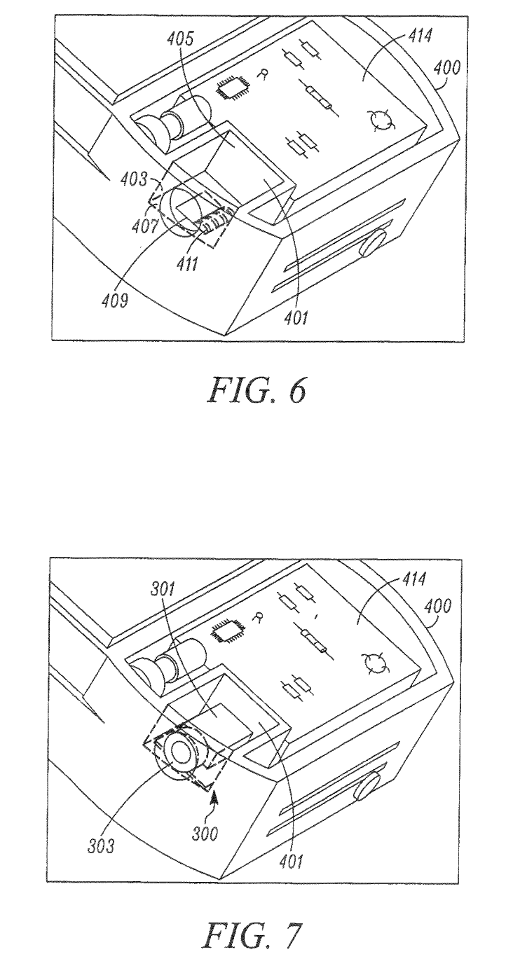

FIG. 6 is a top perspective view of the compartment and aperture used in connection with the submersible electrical connector assembly of the present invention. In order to prevent the entry of water through the connector assembly, an electrical device housing 400 includes a compartment 401 with is configured into a side portion 403 of the housing 400. In this example, the compartment 401 is configured into a substantially cubical like configuration having a plurality of walls 405 surrounding a substantially flat bottom surface 407. An aperture 409 is positioned within the bottom surface 407 which exposes one or more contacts 411 for connecting to pads 313 as seen in FIG. 5. It will be evident to those skilled in the art that any type of flex or zebra strip type connectors can be used to connect with the pad 313 to make an electrical connection.

FIG. 7 is a top perspective view of the submersible electrical connector assembly 300 installed in the compartment 401. In this configuration the adhesive 311 is sealed around the aperture 409 such that the connector body 301 and cylindrical ring 303 is positioned so that it faces though the opening in the compartment 401. This allows the user of the device easy access to the submersible electrical connector assembly when connecting a peripheral device or accessory.

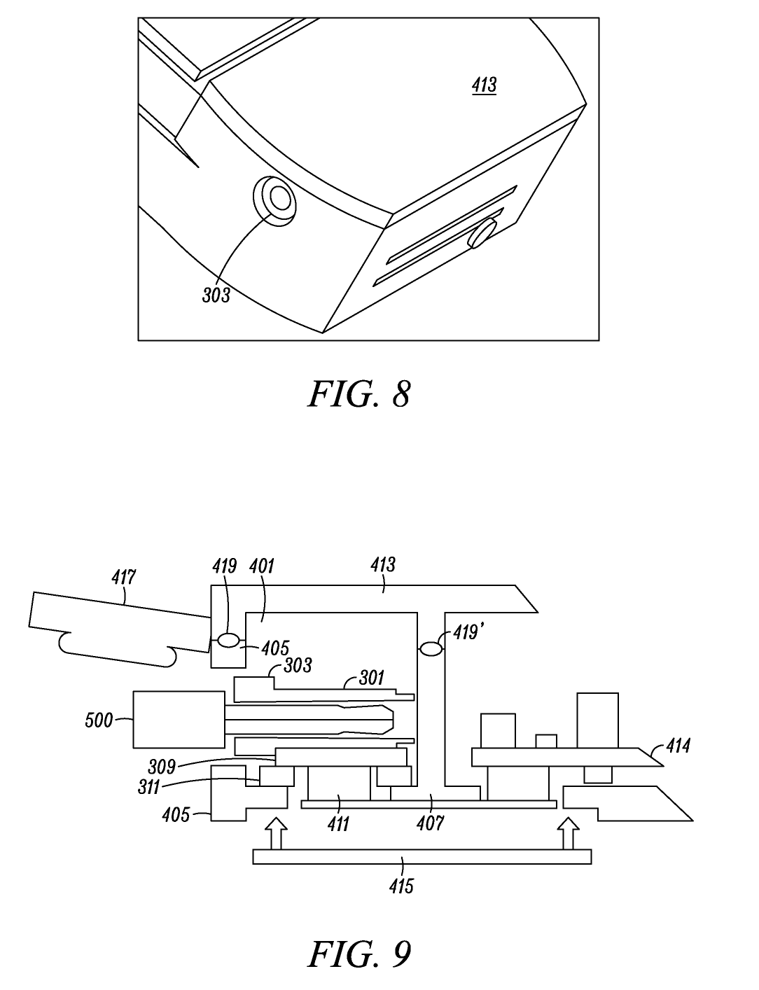

FIG. 8 is a top perspective view of submersible electrical connector assembly with a cover 413 over the compartment 401 and loaded against the walls 405 and bottom surface 407. The cover 413 works to isolate the housing 301 and provide an attractive fit and finish for the device. Those skilled in the art will recognize that the cover 413 is not intended to seal the compartment 401 but merely acts as a cover to protect against dust or other debris from contacting the electrical connector assembly 300.

Finally, FIG. 9 is a side sectional view of the submersible electrical connector assembly as shown in FIGS. 6-8. The side sectional view illustrates the compartment 401 formed with the walls 407 and bottom surface 407. With a plug 500 connected within the housing 301, even if the device were submerged in water, the water can enter the compartment 401 but would be prevented from entering the aperture 409 in view of the sealed connection between the adhesive pad 311 and the surface 407. This would prevent water contacting both contact 411 or electrical components 413. In addition, the perimeter seal 415 works to prevent water from entering around the perimeter of the housing of the electronic device. When the plug 500 is removed, then the dust cover 417 can be reinserted in the aperture formed in the side portion 403.

Thus, the present invention takes an off the shelf connector assembly and places it into a separate carrier board. The carrier board contains contacts pads opposite to the connector. An adhesive pad is used to attached this subassembly to the sealed radio. A cover is then placed over the subassembly for keeping the adhesive pad sealed to the radio. Contact is made to the subassembly via a standard compression connector (z-axis pad or battery style contacts). Although water is allowed to enter the electrical device housing, the water will not breach the housing of the device allowing the water to effect internal electronics.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A submersible electrical connector assembly comprising:
at least one electrical connector mounted to a first substrate;
a second substrate adjoining the first substrate comprising a pliable material for acting as a seal; and
wherein the first substrate and second substrate are positioned within a compartmentalized area of an electrical device housing for preventing a fluid material from entering an aperture within the housing.

2. A submersible electrical connector assembly as in claim 1, wherein the first substrate is a printed circuit board (PCB).

3. A submersible electrical connector assembly as in claim 1, wherein the second substrate is a high adhesive bonding material.

4. A submersible electrical connector assembly as in claim 1, further comprising: at least one electrical connection located opposite the at least one electrical connector on the first substrate.

5. A submersible electrical connector assembly as in claim 4, wherein the second substrate surrounds the at least one electrical connection.

6. A submersible electrical connector assembly as in claim 1, wherein the compartmentalized area is sealed when a male electrical connector is inserted in the submersible electrical connector assembly.

7. A submersible electrical connector assembly as in claim 1, wherein the assembly is used in a two-way radio transceiver.

8. A submersible electrical connector assembly for use in preventing fluids from entering an electronic device comprising:
an electrical connector having at least one contact pad;
a first substrate for use with the electrical connector;
a second substrate surrounding at least a portion of the at least one contact pad; and
wherein the second substrate is positioned above an aperture located within a compartment of the electronic device for allowing the at least one contact pad to make a sealed electrical connection.

9. A submersible electrical connector assembly as in claim 8, wherein the compartment is located in a housing of the electronic device.

10. A submersible electrical connector assembly as in claim 8, wherein the first substrate is a printed circuit board (PCB).

11. A submersible electrical connector assembly as in claim 8, wherein the second substrate is an adhesive material impervious to water.

12. A submersible electrical connector assembly as in claim 8, wherein the at least one contact pad is connectable to an electrical flex cable.

13. A submersible electrical connector assembly as in claim 8, wherein the compartment is substantially sealed when a male electrical connector is inserted in the submersible electrical connector assembly.

14. A submersible electrical connector assembly as in claim 8, wherein the electronic device is a two-way radio transceiver.

15. A method for forming a submersible electrical connector assembly for an electronic device comprising the steps of:
mounting an electrical connector to a first substrate such that at least one contact pad is accessible below the first substrate;
affixing the first substrate upon a second substrate wherein the second substrate includes at least one point for accessing the at least one contact pad;
positioning the first substrate and second substrate over an aperture located in a compartment of a housing for an electronic device; and
forming a water tight seal between the second substrate and a surface around the aperture for preventing the entry of water when the electrical device is submerged.

16. A method for forming a submersible electrical connector assembly as in claim 15, wherein the first substrate is a printed circuit board (PCB).

17. A method for forming a submersible electrical connector assembly as in claim 15, wherein the second substrate is an adhesive material impervious to water.

18. A method for forming a submersible electrical connecter assembly as in claim 15, further comprising the step of:
connecting the at least one contact pad to an electrical flex cable.

19. A method for forming a submersible electrical connector assembly as in claim 15, further comprising the step of:
substantially sealing the compartment when a male electrical connector is inserted in the submersible electrical connector assembly.

20. A method for forming a submersible electrical connector assembly as in claim 15, wherein the electronic device is a two-way radio transceiver.
